(19) United States
(12) Patent Application Publication
(10) Pub. No.: US 2018/0169920 A1
(43) Pub. Date: Jun. 21, 2018

(54) MOLDING STRUCTURE AND HEATING METHOD THEREOF

(71) Applicant: Chung-Yuan Christian University, Tao Yuan County (TW)

(72) Inventors: SHIA-CHUNG CHEN, Tao Yuan County (TW); YUNG-HSIANG CHANG, Tao Yuan County (TW); KUAN-HUA LEE, Tao Yuan County (TW); JEN-AN CHANG, Tao Yuan County (TW); YU-TSENG LIN, Tao Yuan County (TW)

(21) Appl. No.: 15/464,876

(22) Filed: Mar. 21, 2017

(30) Foreign Application Priority Data
Dec. 19, 2016 (TW) 105142105

(51) Int. Cl. B29C 45/73; B29C 45/27

(52) U.S. Cl. CPC B29C 45/73; B29C 2045/7343; B29C 45/2701

(57) ABSTRACT

A molding structure comprising a first mold body, a second mold body suited for combining with the first mold body, a molding core, a first heating element, and a second heating element is provided. A mold cavity is formed between the first mold body and the second mold body when the first mold body and the second mold body are joined together. The molding core is disposed in the mold cavity, wherein the molding core comprises a body, an inner surface, and an outer surface. The first heating member is disposed through the body to heat the molding core. The second heating element is movably disposed on the outer surface of the molding core to preheat the molding core.

### BACKGROUND OF THE INVENTION

### 1. Field of the Invention

The present invention relates to a molding structure and a heating method thereof, and more particularly, to a molding structure for injection molding and a heating method thereof.

### 2. Description of the Related Art

Generally, when using a mold in the injection molding process, in order to maintain smooth and steady flow of the plastic melt injected into the mouth of the mold and to prevent the plastic melt from premature cooling and forming, the male mold and the female mold are preheated to a predetermined temperature before they are joined together for injection molding, thereby allowing the plastic melt to flow smoothly to the mold cavity and then to be molded by cooling and forming.

Common mold preheating methods include radio frequency heating, infrared heating, and so on. However, when using either infrared or RF heating to heat the mold, the temperature of the steel mold core could rapidly drop during the period of time when the plastic melt is injected into the mold and the male and female molds are joined together, which is due to the high thermal conductivity of the steel mold core; resulting in declining temperature of the cavity mold in subsequent injections of plastic melts and affecting molding results. In other words, because the cooling rate of the temperature of the mold core goes too fast, the plastic melt injected into the mold cavity immediately cools down since the temperature of the mold cavity is significantly lower, which leads to problems such as incomplete injection molding, excessive molding pressure and poor product surface. Therefore, it is necessary to propose improved heating method for injection molding.

### SUMMARY OF THE INVENTION

It is an object of the present invention to provide a molding structure to mold the plastic material completely and uniformly without any problems of incomplete injection molding, excessive molding pressure and poor product surface.

In order to achieve the above object, the present invention provides a molding structure, which comprises a first mold body, a second mold body suited for combining with the first mold body, a mold core, a first heating element, and a second heating element. A mold cavity is formed between the first mold body and the second mold body when the first mold body and the second mold body are joined together. The mold core is disposed in the mold cavity, wherein the mold core comprises a body, an inner surface, and an outer surface. The first heating element is disposed through the body to heat the mold core. The second heating element is movably disposed on the outer surface of the molding core to preheat the molding core.

In the present invention, an intermittent heating is performed by the first heating element to the mold core to maintain a heating temperature when the second heating element is removed from the outer surface or the second heating element stops heating the second heating element.

In the present invention, the intermittent heating is performed by stopping heating for a first period when the temperature of the mold core reaches a predetermined temperature, then followed by heating for a second period, and then stopping heating for the first period, followed by heating for the second period, thereby maintaining the heating temperature of the mold core.

In the present invention, the body is disposed with a plurality of through grooves, and the first heating element is disposed in the plurality of through grooves.

In the present invention, the second mold body comprises a groove having the mold core disposed therein; the inner surface of the mold core is connected with the second mold body, and the outer surface of the mold core is facing toward the first mold body.

In the present invention, a plastic injection space is formed between the outer surface and the first mold body when the first mold body and the second mold body are joined together.

In the present invention, the molding structure further comprises a runner formed in the first mold body and/or the second mold body, the runner runs from outside to penetrate through the mold cavity for injecting plastic material through the runner.

The present invention provides a heating method of a molding structure comprising: providing a second mold body; providing a mold core suited to be disposed on the second mold body, wherein the mold core comprises a body, an inner surface, and an outer surface; providing a first heating element disposed through the body to heat the mold core; and providing a second heating element movably disposed on the outer surface of the molding core to preheat the molding core.

In the present invention, an intermittent heating is performed by the first heating element to the mold core to maintain a heating temperature of the mold core when the second heating element is removed from the outer surface or the second heating element stops heating the second heating element.

In the present invention, the intermittent heating is performed by stopping heating for a first period when the temperature of the mold core reaches a predetermined temperature, then followed by heating for a second period, and then stopping heating for the first period, followed by heating for the second period, thereby maintaining the heating temperature of the mold core.

In the present invention, the body is disposed with a plurality of through grooves, and the first heating element is disposed in the plurality of through grooves.

The present invention further provides a first mold body suited for combining with the second mold body, wherein a mold cavity is formed between the first mold body and the second mold body when the first mold body and the second mold body are joined together.

In the present invention, the second mold body comprises a groove having the mold core disposed therein; the inner surface of the mold core is connected with the second mold body, and the outer surface of the mold core is facing toward the first mold body.

In the present invention, a plastic injection space is formed between the outer surface and the first mold body when the first mold body and the second mold body are joined together.

The present invention further provides a runner formed in the first mold body and/or the second mold body, the runner runs from outside to penetrate through the mold cavity for injecting plastic material through the runner.

### BRIEF DESCRIPTION OF THE DRAWINGS

FIG. 1A illustrates a partial view of a molding structure according to an embodiment of the present invention;

FIG. 1B illustrates a view of a second heating element being removed from the molding structure illustrated in FIG. 1A;

FIG. 1C illustrates a complete view of the molding structure illustrated in FIG. 1A;

FIG. 2 illustrates a view of relative positions of the mold core, the first heating element, and the second heating element according to an embodiment of the present invention;

FIG. 3 illustrates a flowchart of a heating method of the molding structure according to an embodiment of the present invention;

FIG. 4 illustrates a timing chart of the heating method of the molding structure according to an embodiment of the present invention; and

FIG. 5 illustrates an experimental data diagram of the heating method of the molding structure according to an embodiment of the present invention.

### DETAILED DESCRIPTION OF THE PREFERRED EMBODIMENT

The advantages and innovative features of the invention will become more apparent from the following detailed description when taken in conjunction with the accompanying drawings.

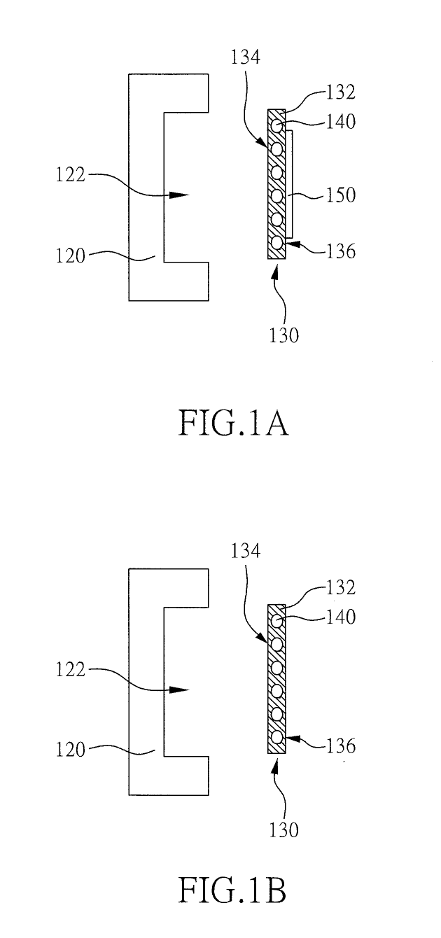

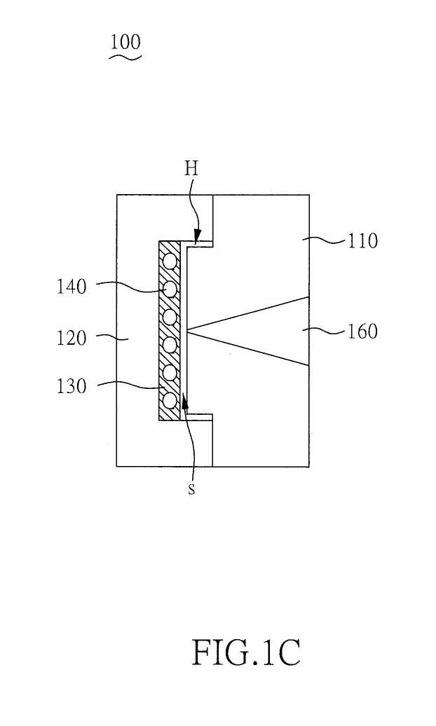

FIG. 1A illustrates a partial view of a molding structure according to an embodiment of the present invention. FIG. 1B illustrates a view of a second heating element being removed from the molding structure illustrated in FIG. 1A. FIG. 1C illustrates a complete view of the molding structure illustrated in FIG. 1A. FIG. 2 illustrates a view of relative positions of the mold core, the first heating element, and the second heating element according to an embodiment of the present invention. Please refer to FIG. 1A, FIG. 1B, FIG. 1C, and FIG. 2, according to the embodiment of the present invention, a molding structure 100 comprises a first mold body 110, a second mold body 120 suited for combining with the first mold body 110, a mold core 130, a first heating element 140, and a second heating element 150. A mold cavity H is formed between the first mold body 110 and the second mold body 120 when the first mold body 110 and the second mold body 120 are joined together. In the embodiment, the first mold body first mold body 110 is, for example, a male mold, and the second mold body second mold body 120 is, for example, a female mold

On the other hand, in this embodiment, the mold core 130 is disposed in the mold cavity H, wherein the mold core 130 comprises a body 132, an inner surface 134, and an outer surface 136. Furthermore, in this embodiment, the second mold body 120 comprises, for example, a groove 122, and the mold core 130 is disposed in the groove 122. That is, the inner surface 134 of the mold core 130 is connected with the second mold body 120, and the outer surface 136 of the mold core 130 is facing toward the first mold body 110. Hence, a plastic injection space S is formed between the outer surface 136 of the mold core 130 and the first mold body 110 when the first mold body 110 and the second mold body 120 are joined together.

It is noted that in this embodiment, the body 132 is disposed with a plurality of through grooves 132a, and the first heating element 140 is disposed in the plurality of through grooves 132a. As a result, the first heating element 140 can heat the core mold 130. In detail, the first heating element 140 is, for example, a line-type heating element. The first heating element 140 penetrates from one side S11 of the mold core 130 into the mold core 130 to be disposed along the through groove 132a in the body 132, and then comes out from the other side surface S12 to enter the other through groove 132a, and then exits from the side surface S11 to form a heating circuit, thereby allowing the mold core 130 to be uniformly heated.

On the other hand, the second heating element 150 is movably disposed on the outer surface 136 of the mold core 130. The second heating element 150 is, for example, a heating coil attached to the outer surface 136 of the mold core 130 to rapidly and uniformly heat the surface of the mold core 130 facing toward the first mold body 110. In other words, the present invention uses the first heating element 140 to heat the mold core 130, and at the same time uses the second heating element 150 to rapidly heat the mold core 130 to a predetermined temperature (as shown in FIG. 1A). As a result, during the injection molding process, the first heating element 140 and second heating element 150 can be used to rapidly heat the mold core 130 to a predetermined temperature, wherein the first heating element 140 and the second heating element 150 can be electrically coupled to the same power supply (not shown in figures). Of course, the first heating element 140 and the second heating element 150 may also be electrically coupled to different power supplies. Therefore, the embodiments are not regarded as limiting examples.

On the other hand, in this embodiment, the second heating element 150 is used to heat the mold core 130 before the first mold body 110 and the second mold body 120 are joined together. When the temperature of the mold core 130 reaches the predetermined temperature, the second heating element 150 is removed and only the first heating element 140 is used to heat the mold core 130 (as shown in FIG. 1B). Alternatively, in other preferred embodiments, the second heating element 150 can be disposed on the mold core 130 in other suitable configurations and can still be used in the subsequent injection molding process. Therefore, the present invention does not limit the use of the second heating element 150 as to preheat the mold core 130 before the first mold body 110 and the second mold body 120 are joined together.

In this embodiment, the molding structure 100 further comprises a runner 160 formed in the first mold body 110 and/or the second mold body 120, the runner 160 runs from outside to penetrate through the mold cavity H for injecting plastic material through the runner 160. Therefore, when the mold core 130 is heated by the first heating element 140 and the second heating element 150 to rapidly reach the predetermined temperature, the second heating element is removed from the outer surface or the second heating element stops heating the second heating element. During the mold injection process, the present invention only uses the first heating element 140 to perform an intermittent heating to the mold core 130, thereby maintaining the temperature of the mold core 130 in a specific temperature range. Hence, when the plastic material is injected into the plastic injection space S through the runner 160, the plastic material can be completely and uniformly molded without any problems of incomplete injection molding, excessive molding pressure and poor product surface.

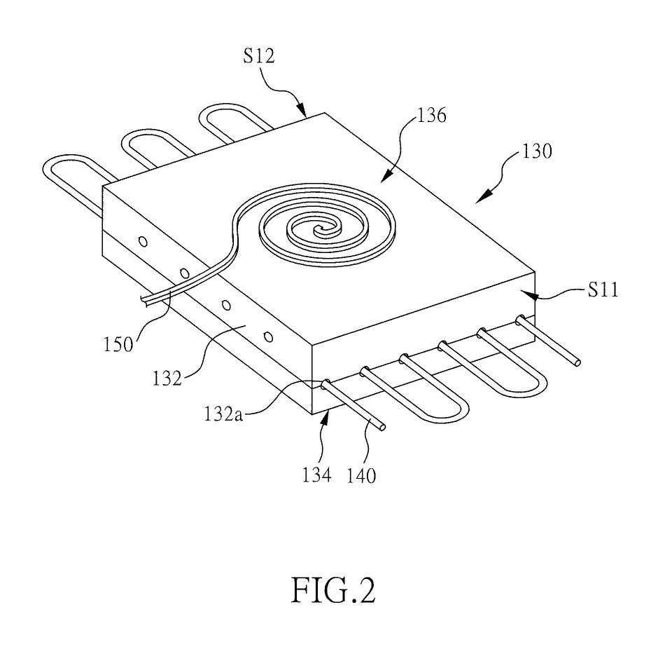

FIG. 3 illustrates a flowchart of a heating method of the molding structure according to an embodiment of the present invention. Please refer to FIG. 3, the heating method of the molding structure comprises the following steps: first, as described in step S110, providing a second mold body. Next, as described in step S120, providing a mold core suited to be disposed on the second mold body, wherein as described above, the mold core 130 comprises a body 132, an inner surface 134, and an outer surface 136, the body 132 is, for example, disposed with a plurality of through grooves 132a. Next, as described in step S130, providing a first heating element disposed through the body of the mold core. In detail, the first heating element is disposed, for example, to go through the plurality of through grooves of the mold core. Next, as described in step S140, providing a second heating element movably disposed on the outer surface of the molding core. Next, as described in step S150, using the first and the second heating element to heat the mold core. Next, as described in step S160, removing the second heating element or stopping the heating operation of the second heating element, using the first heating element to perform the intermittent heating to the mold core and having the first mold body and the second mold body joined together. As described above in the embodiment, the first mold body 110 is suited for combining with the second mold body 120 to form the mold cavity H. Finally, as described in step S170, injecting the plastic material to the space between the second mold body and the first mold body through a runner.

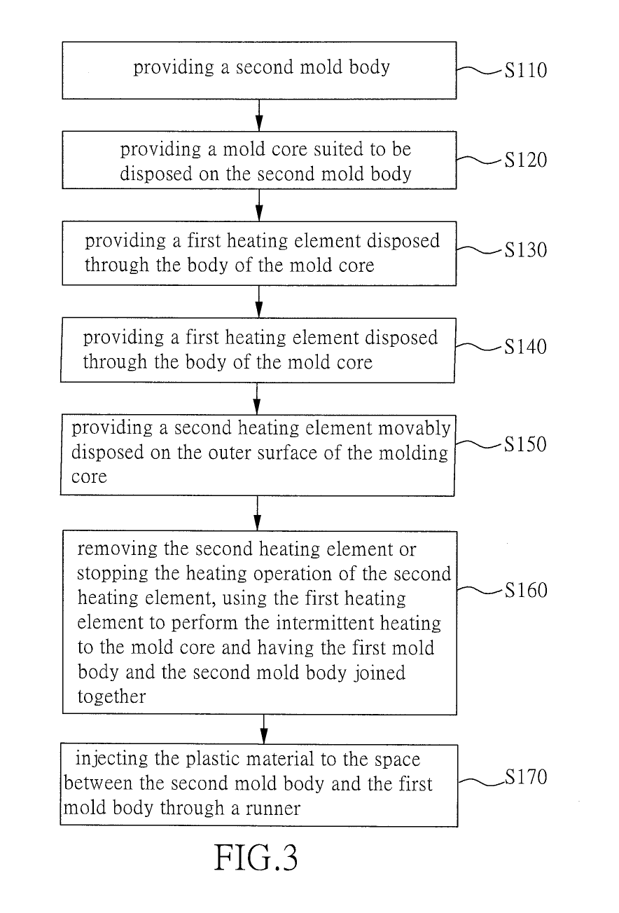

FIG. 4 illustrates a timing chart of the heating method of the molding structure according to an embodiment of the present invention. In FIG. 4, the vertical axis represents the temperature, the horizontal axis represents the time, label L1 is the trace representing heating time of the first heating element 140 versus temperature, label L2 is the trace representing heating time of the second heating element 150 versus temperature. As can be seen from the above description and FIG. 4, in the embodiment, the first heating element 140 and the second heating element 150 are used at the same time to heat the mold core 130. When the mold core 130 is heated to a predetermined temperature T, the second heating element 150 is removed from the mold core 130 or the second heating element 150 stops heating the mold core 130, and then the first heating element 140 performs the intermittent heating to the mold core 130. As a result, when the temperature of the mold core 130 reaches the predetermined temperature T, the trace L2 representing heating time of the second heating element 150 is gone.

As above, in the embodiment, the intermittent heating is, for example, performed by stopping heating for a first period s1 when the temperature of the mold core 130 reaches the predetermined temperature T, then followed by heating for a second period s2, and then stopping heating for the first period s1, followed by heating for the second period s2, and so on. The first period s1 is, for example, 3 seconds, and the second period s2 is, for example, 1 second. In the intermittent heating mode, when the first heating element 140 heats the mold core 130, the temperature of the mold core 130 can rise to T2, wherein T<T2. When the first heating element 140 stops heating the mold core 130, the temperature of the mold core 130 slightly drops to T1, wherein T1<T. In other words, the temperature of the mold core 130 can be effectively maintained in the range between T1 and T2, wherein T1<T<T2. It is noted that the present invention can set the predetermined temperature T, the first period s1, and the second period s2 according to the material property of the mold core or the characteristics of the plastic material, thereby stably maintaining the temperature of the mold core in a stable temperature range (T1 to T2) for a effective period s3. As a result, when the plastic material is injected into the plastic injection space S through the runner 160, the plastic material can be completely and uniformly molded without any problems of incomplete injection molding, excessive molding pressure and poor product surface.

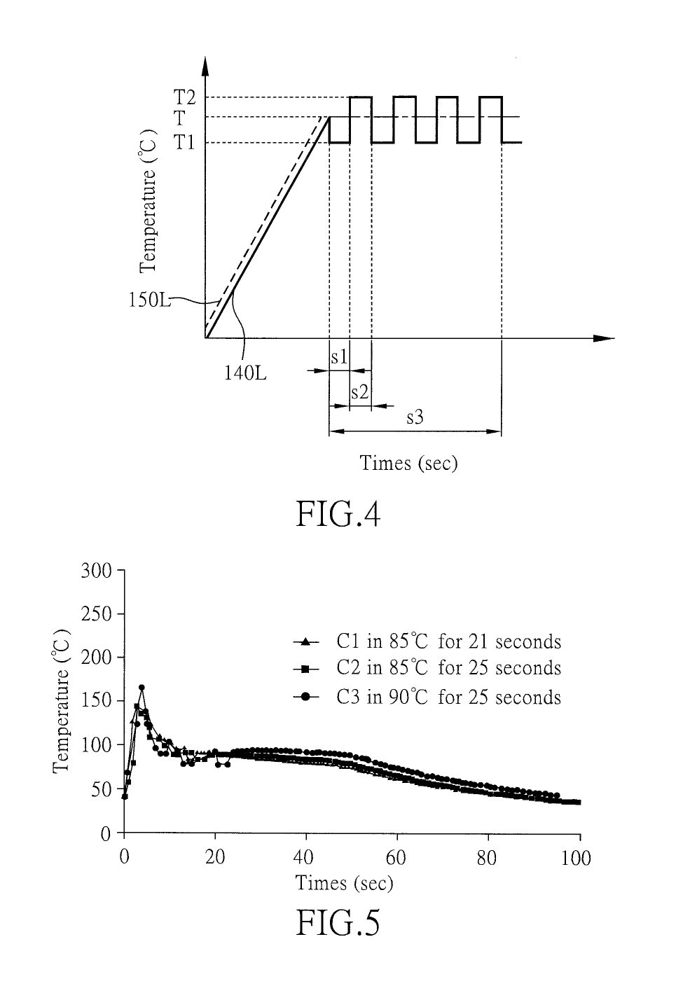

FIG. 5 illustrates an experimental data diagram of the heating method of the molding structure according to an embodiment of the present invention. Please refer to FIG. 5, the heating method of the molding structure starts by using both the first heating element 140 and the second heating element 150 to heat the mold core for 3 second. Next, removing the second heating element 150 and using the first heating element 140 to perform the above-mentioned intermittent heating. The C1 curve shows that the first period s1 of stopping heating is 3 seconds, and the second period s2 of heating is 1 second; the C2 curve shows that the first period s1 of stopping heating is 3 seconds, and the second period s2 of heating is 2 second; the C3 curve shows that the first period s1 of stopping heating is 3 seconds, and the second period s2 of heating is 3 second. As a result, the C1 curve remains in the stable temperature range of around 85° C. for a effective period s3, wherein the effective period s3 is, for example, 21 seconds. Similarly, the C2 curve and the C3 curve also remain in the stable temperature range of around 85° C. and 90° C. respectively for the effective period s3, wherein the effective periods s3 of C2 and C3 are, for example, both 25 seconds. Therefore, the present invention provides a molding structure and its heating method which can effectively maintain the temperature of the mold core for an effective time, which is long enough for the plastic material injected into the runner to smoothly flow to a proper position. In other words, in the present invention, plastic material can be completely and uniformly molded without any problems of incomplete injection molding, excessive molding pressure and poor product surface.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A molding structure comprising:
a first mold body;
a second mold body suited for combining with the first mold body, wherein a mold cavity is formed between the first mold body and the second mold body when the first mold body and the second mold body are joined together;
a mold core disposed in the mold cavity, wherein the mold core comprises a body, an inner surface, and an outer surface;
a first heating element disposed through the body to heat the mold core; and
a second heating element movably disposed on the outer surface of the molding core to preheat the molding core.

2. The molding structure as claimed in claim 1, wherein an intermittent heating is performed by the first heating element to the mold core to maintain a heating temperature when the second heating element is removed from the outer surface or the second heating element stops heating the second heating element.

3. The molding structure as claimed in claim 2, wherein the intermittent heating is performed by stopping heating for a first period when the temperature of the mold core reaches a predetermined temperature T, then followed by heating for a second period, and then stopping heating for the first period, followed by heating for the second period, thereby maintaining the heating temperature of the mold core.

4. The molding structure as claimed in claim 1, wherein the body is disposed with a plurality of through grooves, and the first heating element is disposed in the plurality of through grooves.

5. The molding structure as claimed in claim 1, wherein the second mold body comprises a groove having the mold core disposed therein; the inner surface of the mold core is connected with the second mold body, and the outer surface of the mold core is facing toward the first mold body.

6. The molding structure as claimed in claim 1, wherein a plastic injection space is formed between the outer surface and the first mold body when the first mold body and the second mold body are joined together.

7. The molding structure as claimed in claim 1 further comprising a runner formed in the first mold body and/or the second mold body, the runner running from outside to penetrate through the mold cavity for injecting plastic material through the runner.

8. A heating method of a molding structure comprising:
providing a second mold body;
providing a mold core suited to be disposed on the second mold body, wherein the mold core comprises a body, an inner surface, and an outer surface;
providing a first heating element disposed through the body to heat the mold core; and
providing a second heating element movably disposed on the outer surface of the molding core to preheat the molding core.

9. The heating method of the molding structure as claimed in claim 8, wherein an intermittent heating is performed by the first heating element to the mold core to maintain a heating temperature of the mold core when the second heating element is removed from the outer surface or the second heating element stops heating the second heating element.

10. The heating method of the molding structure as claimed in claim 9, wherein the intermittent heating is performed by stopping heating for a first period when the temperature of the mold core reaches a predetermined temperature T, then followed by heating for a second period, and then stopping heating for the first period, followed by heating for the second period, thereby maintaining the heating temperature of the mold core.

11. The heating method of the molding structure as claimed in claim 8, wherein the body is disposed with a plurality of through grooves, and the first heating element is disposed in the plurality of through grooves.

12. The heating method of the molding structure as claimed in claim 8 further comprising providing a first mold body suited for combining with the second mold body, wherein a mold cavity is formed between the first mold body and the second mold body when the first mold body and the second mold body are joined together.

13. The heating method of the molding structure as claimed in claim 8, wherein the second mold body comprises a groove having the mold core disposed therein; the inner surface of the mold core is connected with the second mold body, and the outer surface of the mold core is facing toward the first mold body.

14. The heating method of the molding structure as claimed in claim 12, wherein a plastic injection space is formed between the outer surface and the first mold body when the first mold body and the second mold body are joined together.

15. The heating method of the molding structure as claimed in claim 12 further comprising a runner formed in the first mold body and/or the second mold body, the runner running from outside to penetrate through the mold cavity for injecting plastic material through the runner.
